(19) United States
(12) Patent Application Publication
(10) Pub. No.: US 2007/0044599 A1
(43) Pub. Date: Mar. 1, 2007

(54) Head replaceable hand tools

(76) Inventor: Chih-Ching Hsieh, Taichung (TW)

Correspondence Address: Mr. Phillip LIU, 6980, Whiteoak Dr., Richmond, BC, V7E 4Z9, CA

(21) Appl. No.: 11/214,721

(22) Filed: Aug. 31, 2005

(51) Int. Cl. B25B 23/16; B25G 1/00; B25B 23/00

(52) U.S. Cl. 81/177.85; 81/438

(57) ABSTRACT

A hand tool includes a handle with a polygonal recess defined in a connection end of the handle and a function head has an insertion which is removably inserted into the polygonal recess. The function head is able to engage with an object to be tightened or loosened and rotated with the handle.

### FIELD OF THE INVENTION

The present invention relates to a hand tool, especially for a head replaceable tool and the heads can be connected to the handle of the hand tool at desired angle.

### BACKGROUND OF THE INVENTION

Conventional hand tools 90 are shown in FIGS. 11 to 13 and generally include a handle 92 and a function head 91 which can be a wrench as shown in FIG. 11, a ratchet driving head as shown in FIG. 12 or a ratchet box end as shown in FIG. 13. Each of the above-mentioned hand tools has a fixed function so that the user has to choose one of them according to the object to be tightened or loosened. In other words, the user has to prepare all of the hand tools if the objects to be tightened or loosened have different shapes. In addition, the conventional handle such as disclosed in FIGS. 11 and 13 includes two wide sides and two narrow sides, when the rotational direction of the handle 92 is perpendicular to the narrow side, the narrow side applies a large pressure to the user's hand and which makes the user feel uncomfortable.

The present invention intends to provide a head replaceable hand tool wherein the handle has a connection end for selectively connecting function heads at desired angles.

### SUMMARY OF THE INVENTION

The present invention relates to a hand tool that comprises a handle having a connection end with a polygonal recess defined therein and a function head has an insertion which is removably inserted into the polygonal recess.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the handle of the hand tool of the present invention;

FIG. 2 is an exploded view to show different positioning device for positioning the function head to the connection end of the hand tool of the present invention;

FIGS. 3 and 4 show the hand tool with different function heads of the present invention;

FIG. 5 shows yet another function head and the handle of the hand tool of the present invention;

FIG. 6 shows that the function head is connected to the handle and is rotating an object;

FIG. 7 shows that the function head can be connected to the handle at desired angle;

FIG. 8 shows that a function head is connected to the handle at different angle;

FIG. 9 shows more embodiments of the polygonal recesses of the connection end;

FIG. 10 shows that the connection end is pivotably connected to the handle, and

FIGS. 11 to 13 show three different conventional hand tools.

### DETAILED DESCRIPTION OF THE PREFERRED EMBODIMENT

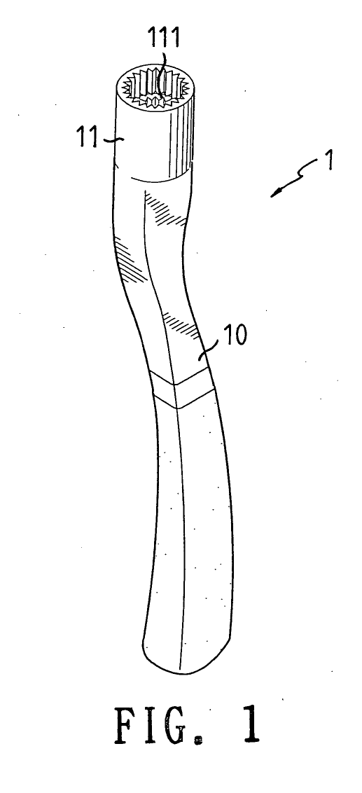

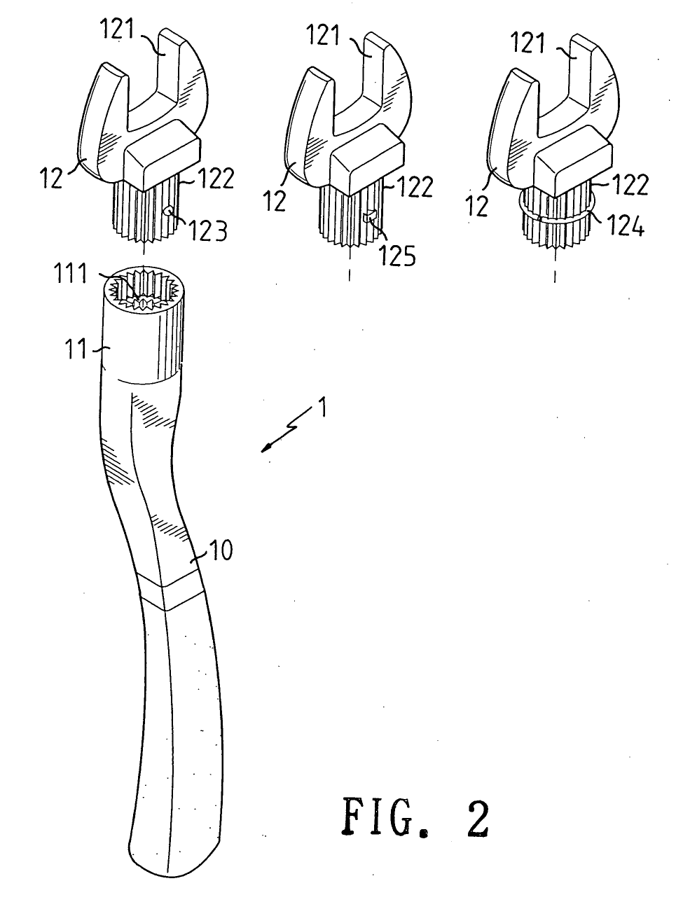

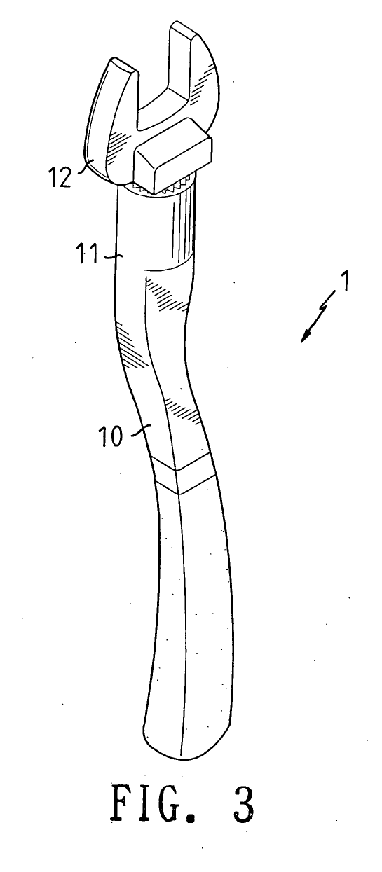

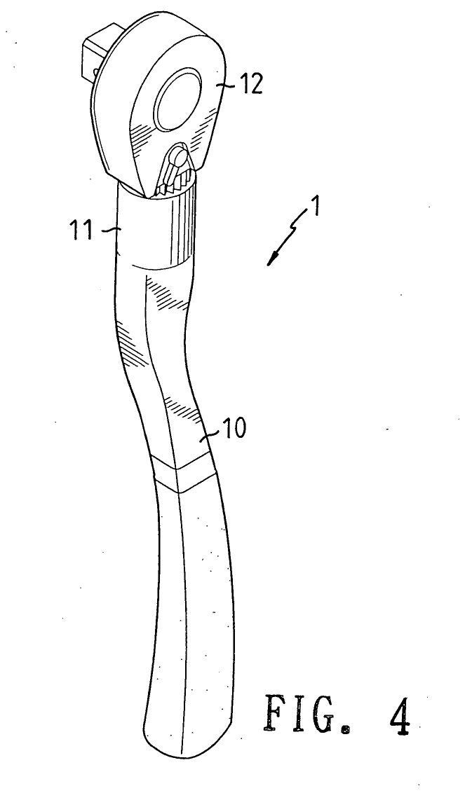

Referring to FIGS. 1 and 2, the hand tool 1 of the present invention comprises a handle 10 having a connection end 11 which includes a polygonal recess 111 defined axially therein. The polygonal recess 111 includes a plurality of parallel and axial ridges and grooves as shown in FIGS. 1 and 2. A function head 12 has an insertion 122 which is axially and removably inserted into the polygonal recess 111. A positioning device is used to position the insertion in the polygonal recess 111, the positioning device can be different forms which will be described hereinafter.

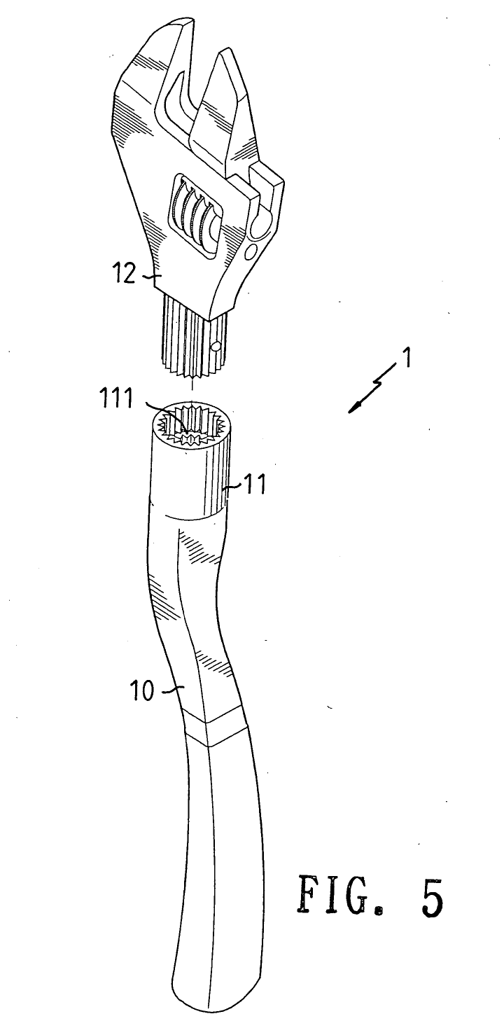

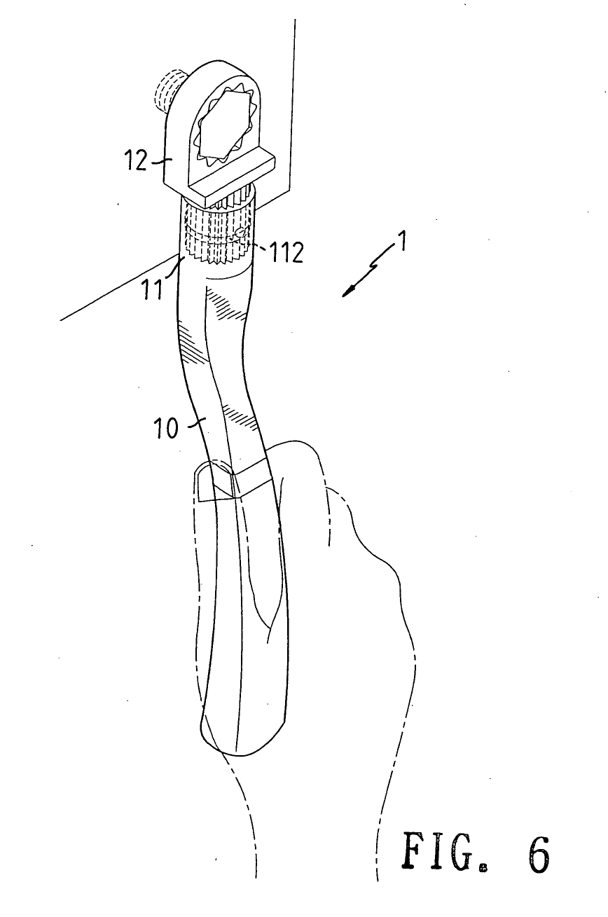

The insertion 122 has a protrusion 123 extends radially from an outer periphery thereof and the inner periphery of the polygonal recess 111 has a notch (not shown) so as to receive the protrusion 123. The insertion 122 may have a magnet 125 connected to an outer periphery thereof so as to be magnetically connected to the inner periphery of the polygonal recess 111. The insertion 122 may have a flexible engaging ring 124 mounted thereto and a groove 112 is defined in an inner periphery of the polygonal recess 111 as shown in FIG. 6, so that the flexible engaging ring 124 is engaged with the groove 112. As shown in FIG. 5, the function head 12 can be an adjustable wrench head.

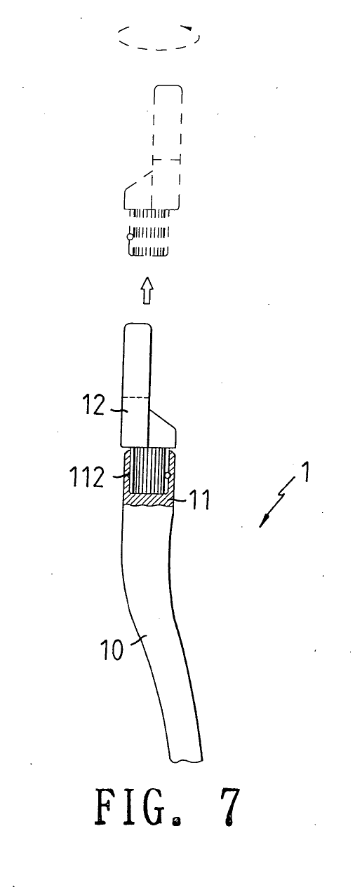

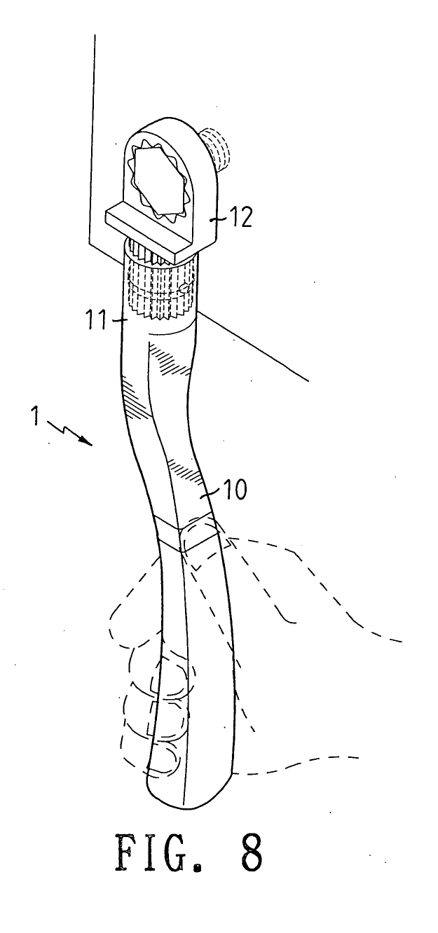

As shown in FIGS. 7 and 8, the function head 12 can be connected to the connection end at desired angle by rotating the function head 12 to a desired angle relative to the connection end 11 so that the direction of rotation of the handle 10 can be set to be perpendicular to the wide surface of the handle 10 to reduce the pressure applied to the user's hand.

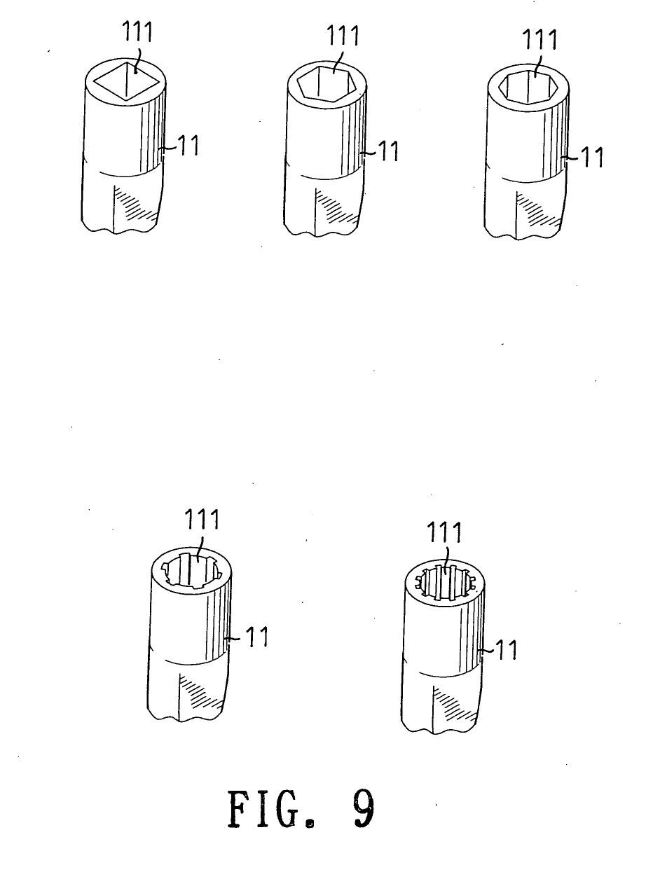

FIG. 9 shows more embodiment of the polygonal recess 111 wherein the polygonal recess 11 can be a multi-side recess. The polygonal recess 111 can also have multiple rectangle-shaped grooves defined longitudinally in an inner periphery of the polygonal recess 11.

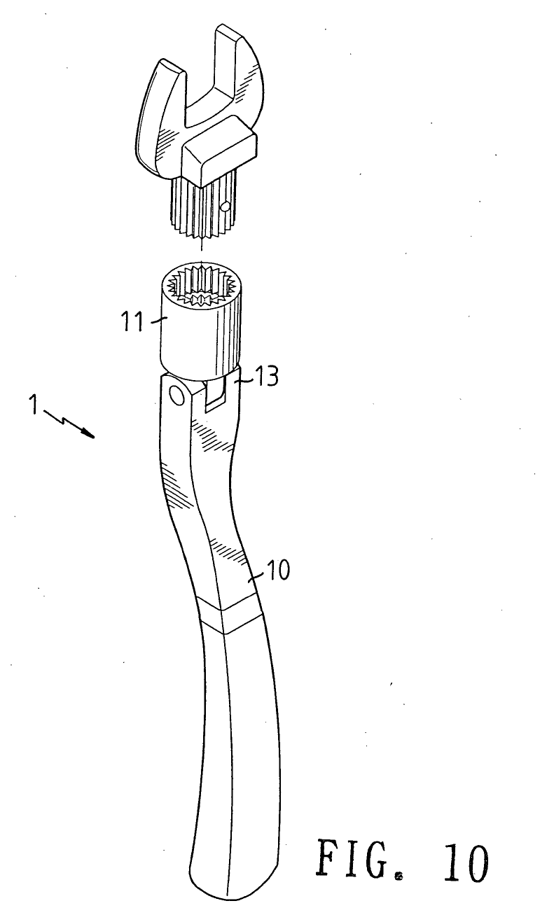

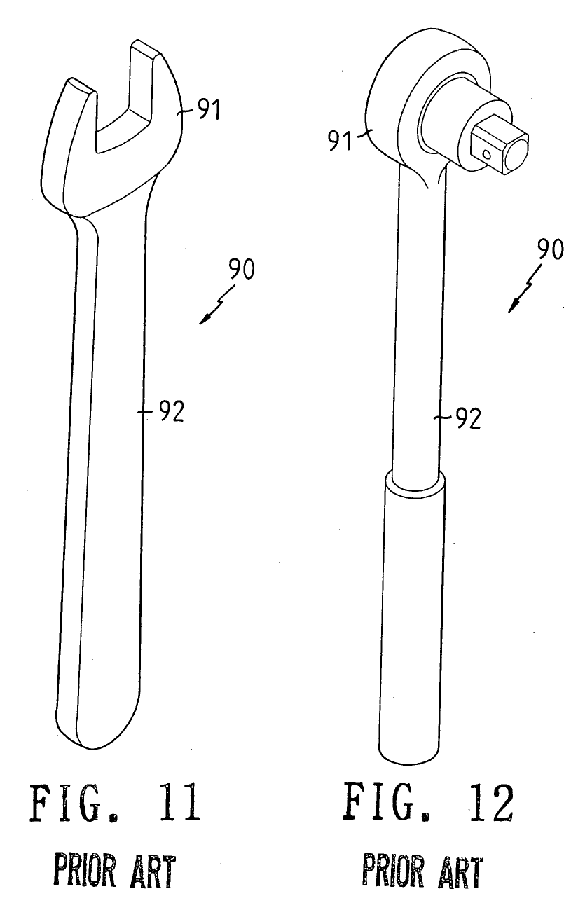

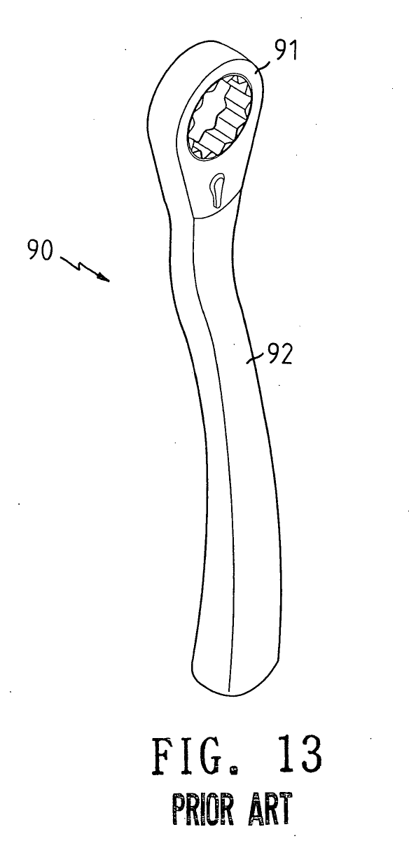

FIG. 10 shows another embodiment of the hand tool of the present invention wherein the handle 10 has two lugs 13 extending therefrom and the connection end 11 is pivotably connected between the two lugs 13. Therefore, the function head and the connection head 11 can be pivoted relative to the handle 10.

While we have shown and described the embodiment in accordance with the present invention, it should be clear to those skilled in the art that further embodiments may be made without departing from the scope of the present invention.

1. A hand tool comprising:
a handle having a connection end which includes a polygonal recess defined therein, and
a function head having an insertion which is removably inserted into the polygonal recess, the insertion having a protrusion extends radially from an outer periphery thereof.

2. The hand tool as claimed in claim 1, wherein the insertion has a protrusion extends radially from an outer periphery thereof.

3. The hand tool as claimed in claim 1, wherein the insertion has a magnet connected to an outer periphery thereof.

4. The hand tool as claimed in claim 1, wherein the insertion 122 has a flexible engaging ring 124 mouted thereto.

5. The hand tool as claimed in claim 1, wherein the polygonal recess includes at least one axial groove defined in an inner periphery thereof.

6. The hand tool as claimed in claim 1, wherein the handle has two lugs extending therefrom and the connection end is pivotably connected between the two lugs.

7. The hand tool as claimed in claim 1, wherein the polygonal recess is defined axially in the connection end and the insertion of the function head is axially inserted into the polygonal recess.
